(19) United States
(12) Patent Application Publication
(10) Pub. No.: US 2020/0300399 A1
(43) Pub. Date: Sep. 24, 2020

(54) REMOTE FLUID RECOVERY OR TRANSFER

(71) Applicant: ARDENT MARITIME UK LIMITED, London (GB)

(72) Inventor: Andrew Barron, Houston, TX (US)

(73) Assignee: ARDENT MARITIME UK LIMITED, London (GB)

(21) Appl. No.: 16/358,124

(22) Filed: Mar. 19, 2019

(51) Int. Cl. F16L 41/06

(52) U.S. Cl. CPC F16L 41/06

(57) ABSTRACT

The present disclosure relates to a method and device for tapping into a vessel, typically to recover fuel or cargo oil from sunken ships but may be applicable to other situations involving transfer of fluids from places that are inhospitable to humans. A remotely operable hot tap installation tool has a releasable securing and stabilising arrangement; a hot tap assembly holder; at least one first drive mechanism configured to apply torque to studs at a plurality of attachment stud locations to securely fasten the hot tap assembly to the vessel; a second drive mechanism configured to apply torque to a hole-drilling assembly to cut a hole into the fluid vessel wall; and an indexing mechanism configured to move the first drive mechanism between multiple attachment stud locations.

### BACKGROUND

A “hot tap” is a connection to a pipe or other pressure vessel made while the system is “live” and contains fluid, rather than one installed at manufacture. When a vessel sinks, recovery of the vessel's fuel or oil as a cargo or other cargo fluids typically requires installing a hot tap if the normal equipment used for loading or unloading is unusable.

In the case the normal equipment is unusable on a sunken ship a hole needs to be drilled in the vessel wall and a connector/pipe assembly attached without allowing the oil or fluid to escape into the marine environment. Devices exist which can be attached to a vessel and seal and provide a connection while a hole is drilled but installing them is a laborious process involving divers and this can be particularly problematic at deep ocean depths. Remote Operated Vehicles (ROVs) are unoccupied vehicles, typically operated by humans nearby, such as aboard a vessel nearby. They are often used underwater at depths that divers are unable to reach. Underwater ROVs are used for inspection and repair of devices that are deep in the water and where it would be too dangerous and/or too deep to send a diver.

Whilst in principle it might seem possible to use the remote grippers provided on commercially available ROVs to try and mimic the actions performed by divers to install known hot taps, this is not straightforward for a number of reasons and in general ships lost beyond a certain depth have simply been abandoned with their fuel unrecovered and posing a potential environmental risk ever since fuel-oil powered shipping began. Another issue is that the fuel at the low temperatures prevailing at such depths tends to be highly viscous and difficult to extract even if a tap were able to be provided.

Aspects of the present disclosure seeks to address the problems outlined above.

### SUMMARY

Aspects of the disclosure are set out in the accompanying claims.

The present disclosure relates to a method and device for tapping into a vessel, typically to recover fuel or cargo oil from sunken ships but may be applicable to other situations involving transfer of fluids from places that are inhospitable to humans.

There is described herein a remotely operable hot tap installation tool for securing a hot tap assembly to a vessel, wherein the hot tap assembly comprises: a connection plate, a fluid connection port, a plurality of attachment stud locations, a hole-drilling assembly; and wherein the vessel is arranged to contain fluid and has a wall; the remotely operable hot tap installation tool comprising: a releasable securing and stabilising arrangement configured to securely position the tool with respect to the vessel by attaching to the vessel wall; a hot tap assembly holder arranged to hold the hot tap assembly with respect to the tool with the connection plate adjacent the vessel wall when the releasable securing and stabilising arrangement is activated; at least one first drive mechanism configured to apply torque to studs at the plurality of attachment stud locations of the hot tap assembly to securely fasten the hot tap assembly to the vessel; a second drive mechanism configured to apply torque to the hole-drilling assembly of the hot tap assembly to cut a hole into the fluid vessel wall to allow fluid communication between the fluid vessel and hot tap; an indexing mechanism configured to move the first drive mechanism between multiple attachment stud locations; wherein the attachment stud locations comprise at least three primary attachment stud locations for securing the hot tap assembly to the vessel and at least one secondary attachment stud location and wherein the combination of the or each first drive mechanism and the indexing mechanism is arranged to apply torque selectively to attachment studs at all primary attachment stud locations and at least one secondary attachment stud location.

Preferably the releasable securing and stabilising arrangement comprises one or more attachment elements selected from movable magnets, electromagnets and suction feet.

Preferably the indexing mechanism comprises a third drive mechanism, for moving the first drive mechanism between multiple attachment stud locations.

Preferably the indexing mechanism is configured to move the first drive mechanism to predetermined index locations corresponding to the attachment stud locations (at least to all the primary attachment stud locations and at least one secondary attachment stud location).

Preferably the indexing mechanism comprises a locking mechanism.

Preferably the net weight of the hot tap installation tool in water is adjustable between 30 kg and neutrally buoyant.

Preferably the attachment stud locations comprise at least one secondary attachment stud location for each of the primary attachment stud locations (so there are at least six stud locations in total), and wherein the combination of the or each first drive mechanism and the indexing mechanism is arranged to apply torque selectively to attachment studs at all secondary attachment stud locations.

Preferably the attachment stud locations comprise more than one secondary attachment stud location for each of the primary attachment stud locations (so there are e.g. at least nine stud locations in total).

Preferably the primary attachment stud locations are substantially evenly spaced about the hot tap assembly, e.g. around the circumference of the connection plate.

Preferably the secondary attachment stud locations are offset from the primary attachment stud locations.

Preferably the secondary attachment stud locations are substantially evenly spaced about the hot tap assembly, e.g. around the circumference of the connection plate.

There is described herein a remote operated vehicle comprising the hot tap installation tool of any preceding embodiment, preferably an underwater remote operated vehicle.

There is described herein a fluid vessel comprising a hot tap installed using a hot tap installation tool according to any preceding embodiment.

There is described herein a method of extracting a fluid from a fluid vessel, comprising the steps: installing a first hot tap assembly and a second hot tap assembly in a wall of the fluid vessel; fluidly coupling the first hot tap assembly to a input of a heat exchange device; fluidly coupling the second hot tap assembly to an output of the heat exchange device; fluidly coupling an oil storage tank to the output of the heat exchange device; circulating a fluid in the fluid vessel through the heat exchange device; applying heat to the fluid in the fluid vessel as it flows through the heat exchange device; and pumping the heated fluid from the fluid vessel into the oil storage tank.

Preferably the fluid in the fluid vessel comprises water and another fluid and wherein the other fluid or water is decanted from the fluid from the fluid vessel.

Preferably the other fluid is oil and the decanted fluid is processed using an oil separator system.

Preferably the water output of the oil separator is heated and pumped into the fluid vessel.

Preferably the oil storage tank is part of an above sea arrangement.

Preferably the circulating the fluid in the fluid vessel is performed at a rate of between 1 m³/hr and 30 m³/hr, more preferably between around 5 m³/hr and 20 m³/hr.

Preferably the heat exchange device provides an energy exchange rate of between 400 KW and 1000 KW.

Preferably, the method further comprises pumping the heated fluid from the fluid vessel into the oil storage tank only after the fluid is above (preferably well above) the pour point and/or thermal equilibrium has been achieved.

Preferably the first hot tap assembly and second hot tap assembly are installed using a remotely operable hot tap installation device according to any one the preceding embodiments.

Each of the aspects above may comprise any one or more features mentioned in respect of the other aspects above.

It should be noted that the term “comprising” as used in this document means “consisting at least in part of”. So, when interpreting statements in this document that include the term “comprising”, features other than that or those prefaced by the term may also be present. Related terms such as “comprise” and “comprises” are to be interpreted in the same manner. As used herein, “(s)” following a noun means the plural and/or singular forms of the noun.

Preferred embodiments are now described, by way of example only, with reference to the accompanying drawings.

### DESCRIPTION OF THE DRAWINGS

FIG. 1A and FIG. 1B show a 3D CAD drawing of a hot tap and hot tap installation device.

FIG. 1C and FIG. 1D show a 3D CAD drawing of an alternative a hot tap and hot tap installation device in an alternative embodiment.

FIG. 1E shows a 3D CAD drawing of an example hot tap.

FIG. 2 shows a 3D CAD drawing of a drill assembly.

FIG. 3A shows a 3D CAD drawing of an indexing mechanism.

FIG. 3B and FIG. 3C show a 3D CAD drawing of a detail of an indexing mechanism.

FIG. 4A shows a 3D CAD drawing of a baseplate assembly.

FIG. 4B shows a 3D CAD drawing of the baseplate assembly engaged with a hot tap.

FIG. 5 shows a 3D CAD drawing of a drill stud.

FIG. 6 shows a 3D CAD drawing of a detail of an indexing mechanism, drill assembly, and baseplate assembly.

FIG. 7A and FIG. 7B show flow schematics of an oil extraction system.

### DETAILED DESCRIPTION

### Hot Tap Installation Device and Hot Tap

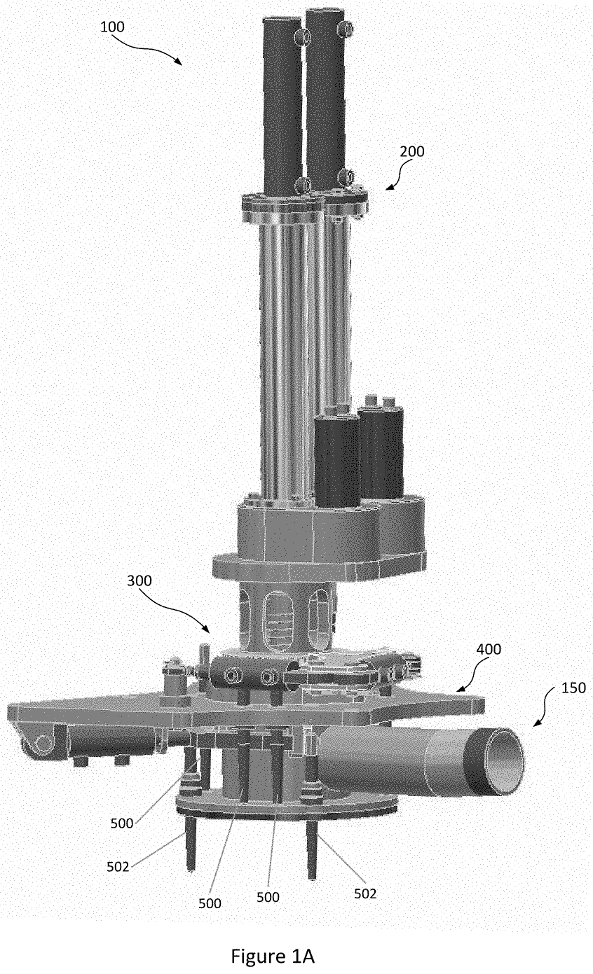

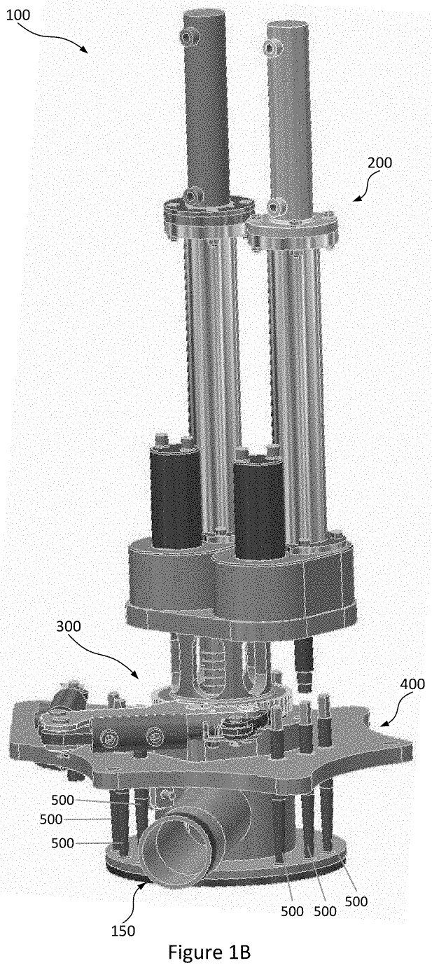

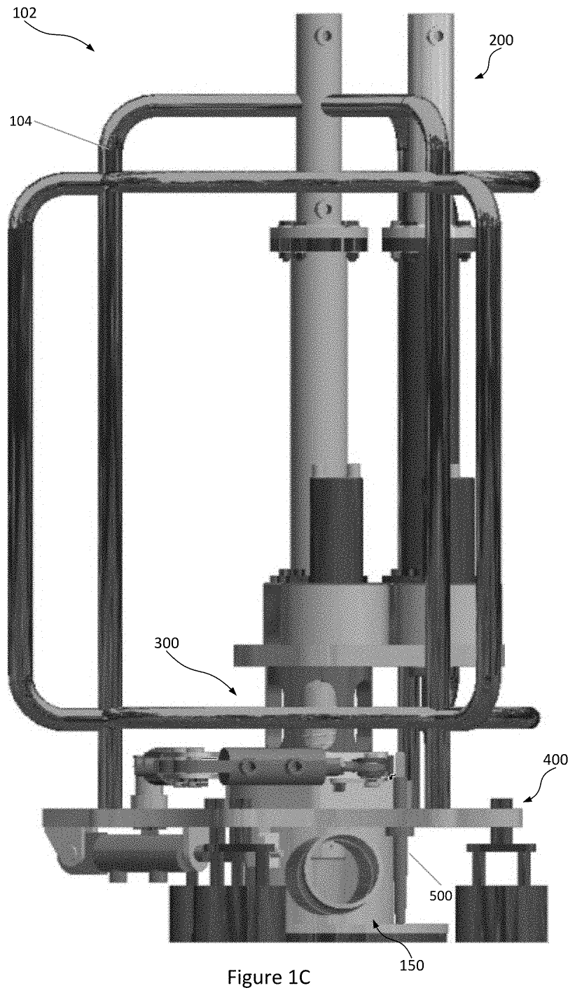

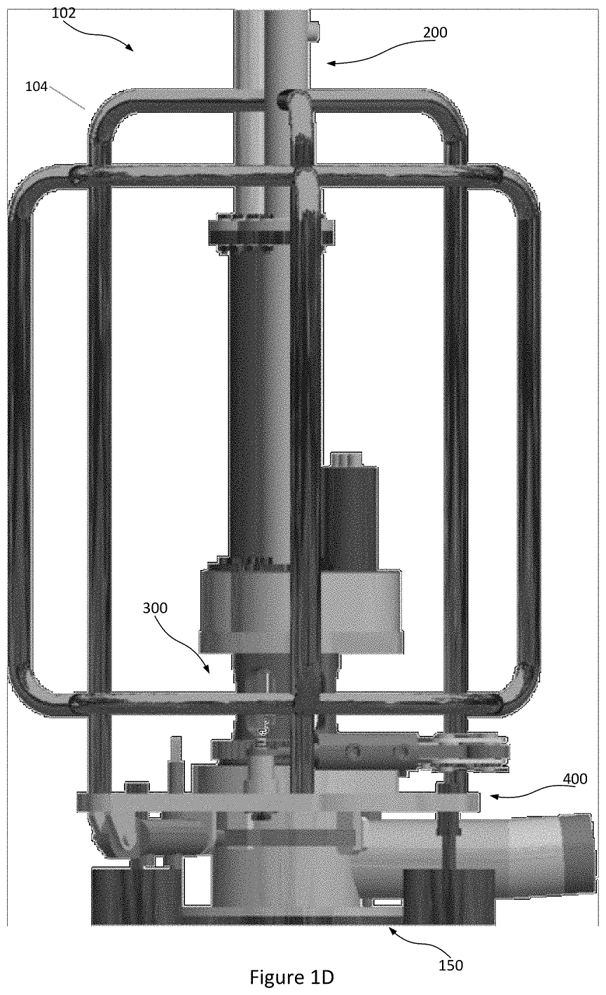

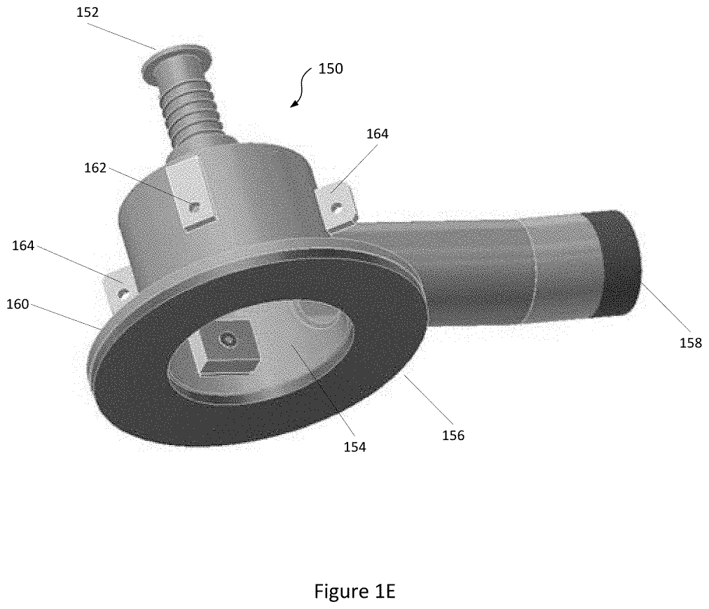

Referring to FIGS. 1A and 1B, according to a first embodiment, a remotely operable hot tap installation device 100 is shown. In the illustrated embodiment, the hot tap assembly 150 is also shown. The hot tap assembly 150 is shown in a position ready to start the installation process. In this example embodiment, the hot tap assembly 150 is to be installed on a vessel containing fluid (not shown). The hot tap assembly 150 is to be installed securely and leak tight onto the fluid vessel. Preferably the fluid vessel the hot tap assembly 150 is to be installed on is a tank. Preferably, the hot tap assembly 150 is arranged to be installed on a flat surface of the tank.

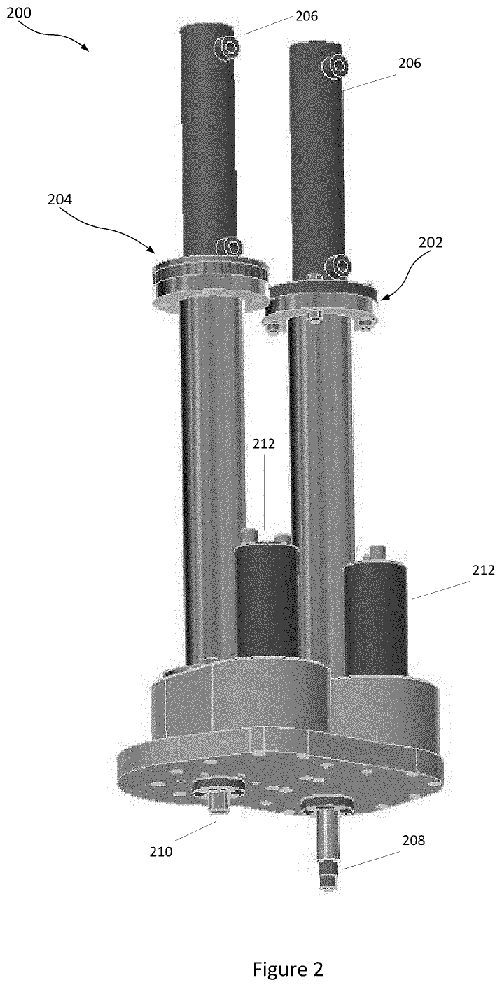

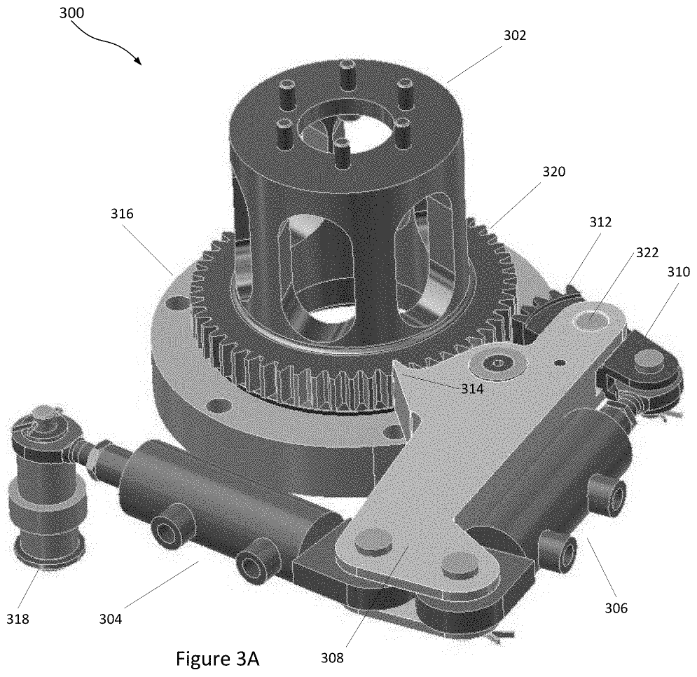

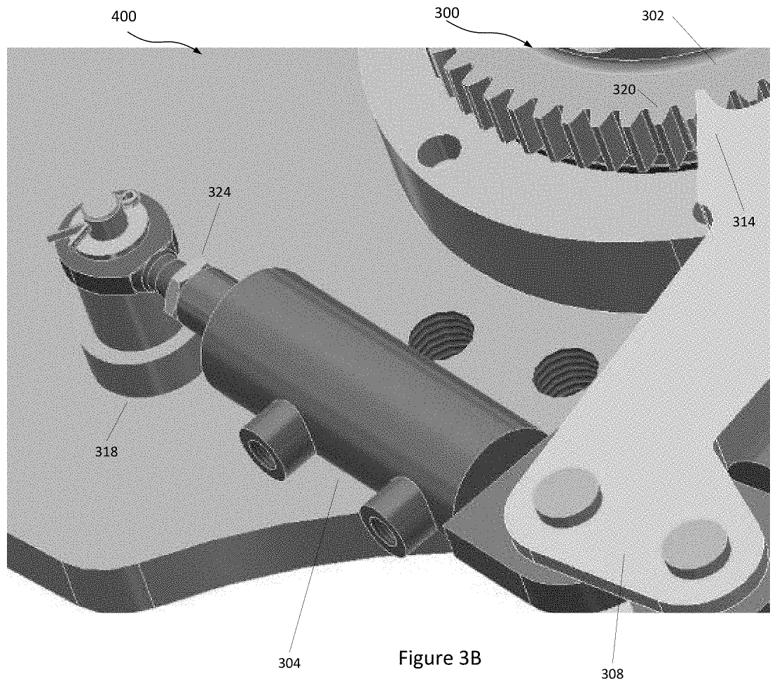

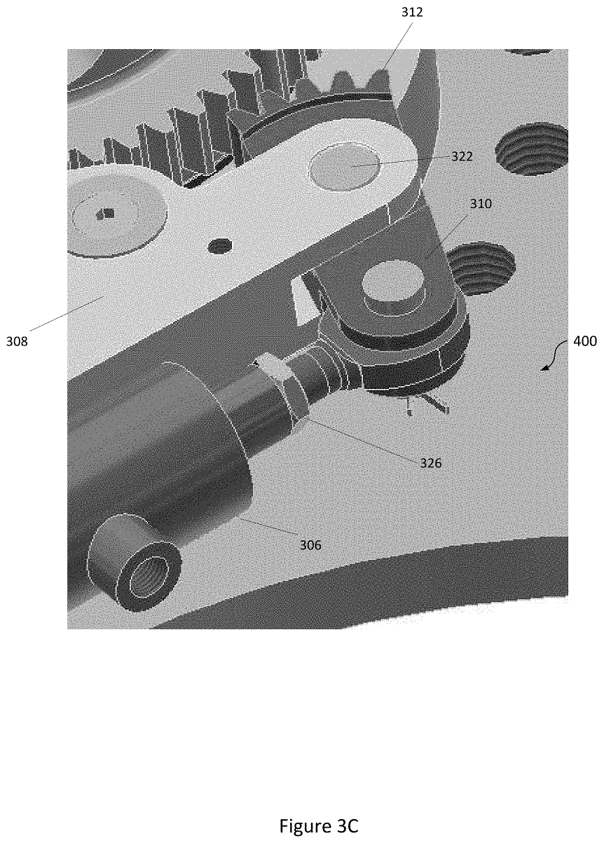

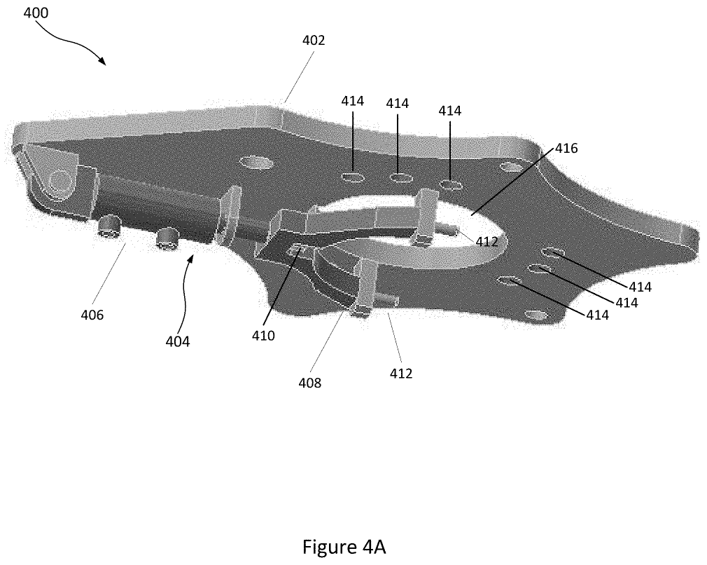

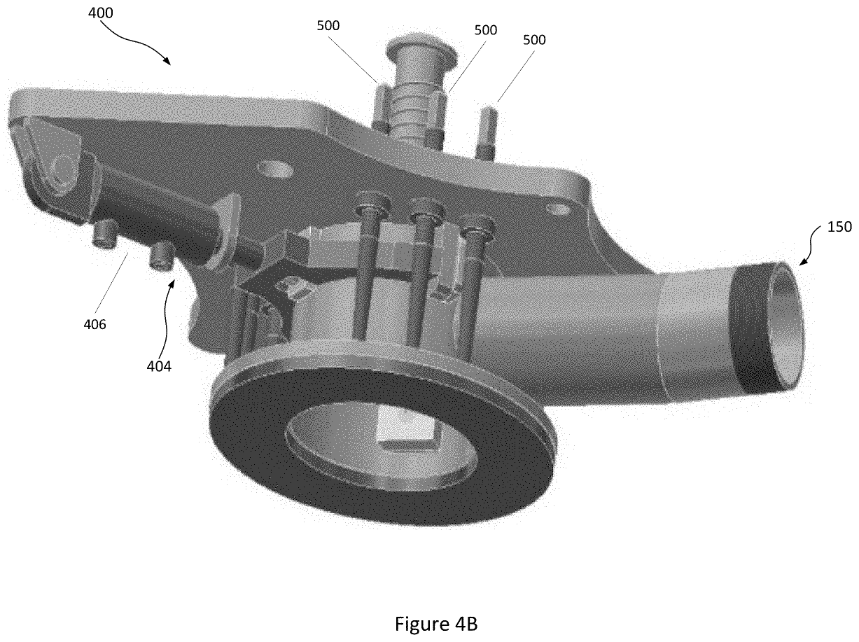

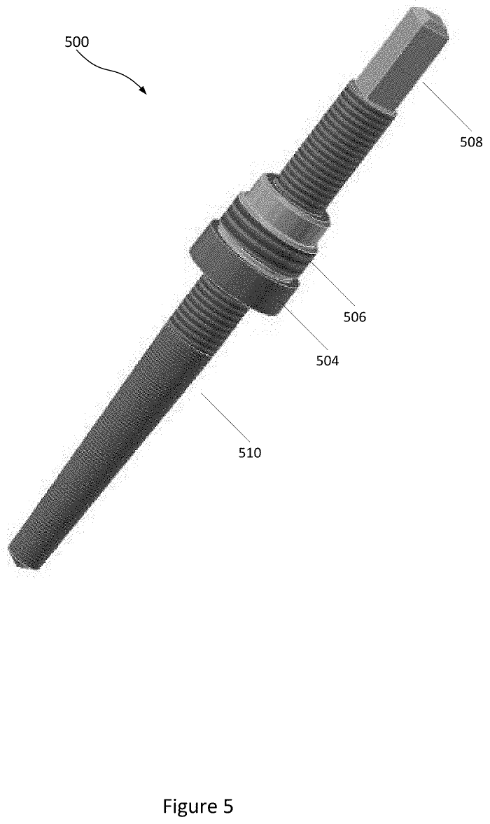

In the present embodiment, the remotely operable hot tap installation tool 100 comprises a number of sub-components: a drill assembly 200, an indexing mechanism 300, and drill studs 500. These sub-components are described in greater detail with reference to FIG. 2, FIG. 3A, FIG. 4A, and FIG. 5 respectively. The hot tap assembly 150 comprises a baseplate assembly 400 and a fluid transfer port.

The drill assembly 200 is configured to apply torque to drill studs 500. When the drill assembly 200 applies torque to the drill studs 500, the drill studs 500 rotate and are drilled in, for example into the wall of the vessel or tank. In other words, the drill assembly 200 is configured to drill in the drill studs 500.

The indexing mechanism 300 is coupled to the drill assembly 200. The indexing mechanism 300 is configured to move the drill assembly 200. In particular, the index mechanism 300 moves the drill assembly 200 to specified indexes. The specified indexes are drilling positions for the drill assembly 300. In this embodiment, the specific indexes are positions where the drill assembly 300 is in a position to apply torque to the drill studs 500. Preferably the index positions correspond to each of a plurality of attachment stud locations on the baseplate 400. For example, the attachment stud locations may be apertures in the baseplate 400.

The indexing mechanism 300 is coupled to the baseplate assembly 400.

The baseplate assembly 400 is configured to removably couple to the hot tap assembly 150. FIG. 1A shows the baseplate assembly 400 already coupled to the hot tap assembly 150. The baseplate assembly 400 is configured to retain drill studs 500, e.g. in stud locations.

The drill studs 500 are configured to drill into and through the hot tap assembly 150 and into or through the fluid vessel wall.

Installing the hot tap assembly 150 using the remotely operable hot tap installation device 100 involves placing the hot tap assembly 150 on a location on the surface of the fluid vessel and temporarily coupling or otherwise steadying the hot tap assembly 150 relative to the fluid vessel such that the hot tap assembly 150 does not move too much during the installation. In other words, the hot tap assembly 150 must temporarily or permanently couple to the fluid vessel while being installed. In this example embodiment, electromagnets are used to temporarily couple the hot tap 150 to the fluid vessel. Alternatively, permanent magnets are used to temporarily couple the hot tap assembly 150 to the fluid vessel. Alternatively, a separate gripping device is used to steady the remotely operable hot tap installation device 100 relative to the fluid vessel. Alternatively, no adhesion or steadying is required.

With the hot tap assembly 150 and/or remotely operable hot tap installation device 100 steadied relative to the fluid vessel, the permanent fixing of the hot tap assembly 150 to the fluid device can start. Alternatively, no steadying or is required and the permanent fixing can start in the first instance.

In this embodiment, permanent fixing involves drilling the drill studs 500 through the hot tap assembly 150 (e.g. through the mounting plate 400) and into the fluid vessel. FIG. 1A shows two drill studs 502 in an installed position. The drill studs 502 have been drilled through a flange 160 of the hot tap assembly 150.

FIG. 1C and FIG. 1D shows a hot tap installation device 102 according to another embodiment. The hot tap installation device 102 is similar to the remotely operable hot tap installation device 100 of the embodiment according to FIG. 1A and FIG. 1B but further comprises a frame 104. The frame 104 is used to attaching to a ROV and/or for a user to operate the hot tap installation device 102.

FIG. 1E shows an example hot tap assembly 150. The hot tap assembly 150 in the present example embodiment is configured to couple with a flat surface. In particular, the hot tap assembly 150 is configured to couple to the flat surface of a tank. When installed, the hot tap 150 will provide a fluid connection to the tank. Other hot taps are known in the art for use with different other fluid vessels. Alternative fluid vessels include pipe lines. It will be appreciated by a person skilled in the art that the remotely operable hot tap installation device 100 may be used with different hot tap devices. The hot tap 150 shown here is for illustrative purposes. For a hot tap configured for use with a pipe line, arrangements and locations of the components of the remotely operable hot tap installation device 100 will need to be rearranged. A person skilled in the art will be able to understand and these adjustments without departing from the scope of this document.

The hot tap assembly comprises a rotatable mechanism 152, an internal chamber 154, a fluid vessel interface surface 156, an outlet 158, and a flange 160. The rotatable mechanism 152 is configured to be rotated by the remotely operable hot tap installation device 100. The rotatable mechanism 152 is coupled to a drilling device (not shown). Preferably the drilling device is part of the hot tap assembly 150.

The fluid vessel interface surface 156 is sealingly attachable to the fluid vessel. The hot tap 150 is installed when the fluid vessel interface surface 156 forms a seal between the hot tap 150 and the fluid vessel. The seal is secure and leak tight.

Once installed, in use, when the rotatable mechanism 152 is rotated, the drilling device is configured to drill a hole into the fluid vessel. The hole is up to four inches in diameter. The hot tap 150 is configured to penetrate up to one inch into the fluid vessel. With the drilling complete, the fluid of the fluid vessel is in communication with the hot tap internal chamber 154 such that the fluid of the fluid chamber can move into the hot tap internal chamber 154. Depending on the qualities of the fluid of the fluid chamber, external forces may be required to move the fluid through into the hot tap internal chamber 154. For example, if the fluid in the fluid chamber is oil, another fluid may be required to pump into the fluid chamber from a second hot tap or opening to force the oil into the internal chamber of the first hot tap.

The internal chamber 154 is in fluid communication with the outlet 158. The outlet 158 is attachable to a fluid communication member (not shown) such that the fluid in the fluid vessel can be extracted. The hot tap assembly 150 is also configured to introduce other materials or fluid into the fluid chamber.

In this embodiment, the flange 160 receives the drill studs 500 (not shown in this figure) to install the hot tap 150 to the fluid vessel.

In this embodiment, the hot tap 150 comprises locking and keying features 162, 164. The locking and keying features are to assist the remotely operable hot tap installation device 100 in attaching to the hot tap assembly 150 securely and accurately. The keying and locking features 162, 164 comprise a tab of known width with a hole of known size to align with the keying and locking features of the remotely operable remotely operable hot tap installation device 100. The keying and locking features of the remotely operable remotely operable hot tap installation device 100 are described with reference to FIGS. 4A and 4B.

In this embodiment, the motors, actuators, and cylinders of the remotely operable hot tap installation device 100 (described in more detail with reference to their specific purposes), are hydraulic powered.

In this embodiment, the weight of the remotely operable hot tap installation device 100 is adjustable. The weight of is the remotely operable hot tap installation device 100 in water is adjustable between 30 kg and neutrally buoyant. The weight of the remotely operable hot tap installation device 100 is adjusted in the field by adding buoyancy members to the remotely operable hot tap installation device 100.

### Drill Assembly

Referring to FIG. 2, according to a first embodiment, a drill assembly 200 is shown. The drill assembly 200 comprises two drive mechanisms configured to apply torque. The first drive mechanism 202 is configured to apply torque to drill studs 500 via the drill stud torque application interface 208. In this embodiment, the drill stud torque application interface 208 is a socket wrench. The second torque application assembly 204 is configured to apply torque to the hot tap assembly 150 via the hot tap torque application interface 210.

Both drive mechanisms 202, 204 comprise a height adjustment mechanism 206 for lowering and raising the torque application interfaces 208, 210. In this embodiment, the height adjustment mechanisms 206 are linear actuators. In particular, the linear actuators are hydraulic cylinders.

Both drive mechanisms 202, 204 comprise torque generation devices 212. In this embodiment, the torque generation devices 212 are hydraulic motors. In alternative embodiments, other torque generation devices 212 may be used such as electric motors.

### Indexing Mechanism

Referring to FIG. 3A, according to a first embodiment, an indexing mechanism 300 is shown. The indexing mechanism 300 is configured to move to indexed positions, and/or move any devices the indexing mechanism 300 is coupled to, to indexed positions. The indexing mechanism 300 comprises a drive mechanism to move to indexed positions.

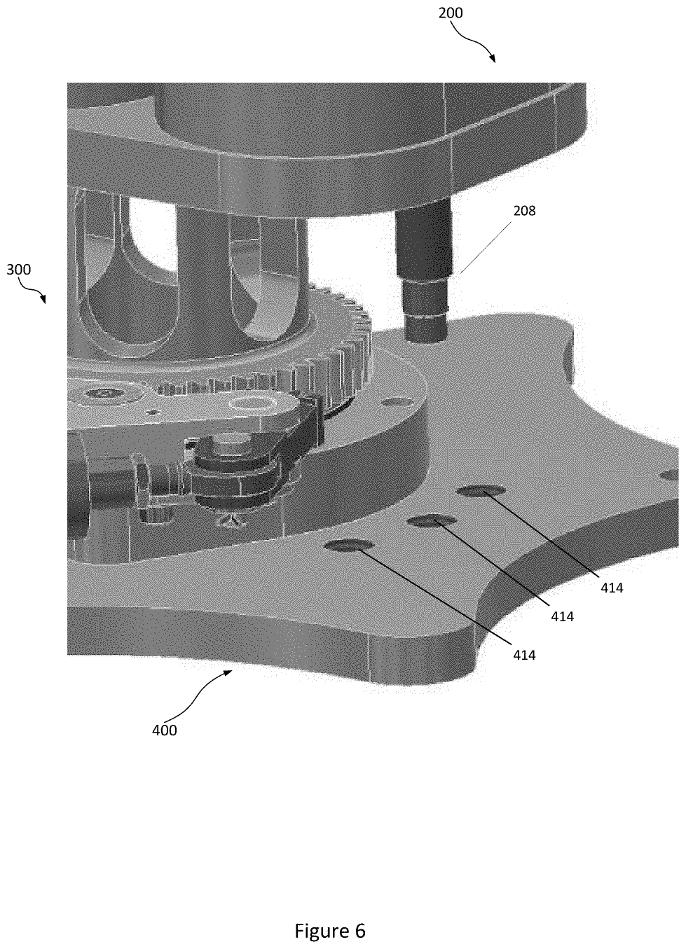

The indexing mechanism 300 is configured to move the first drive mechanism 202 into different positions such that the first drive mechanism 202 can apply torque to the drill studs 500. In this embodiment, the first drive mechanism 202 is part of the drill assembly 200 and the indexing mechanism 300 is configured to move the drill assembly 200 into positions such that the first drive mechanism 202 of the drill assembly 200 can apply torque to the drill studs 500. Further description of the indexing and index positions is described with reference to FIG. 6 and under the heading “Indexing and Indexed Locations”.

In this embodiment, the indexing mechanism 300 is implemented as a rotation mechanism. The indexing mechanism 300 comprises a pedestal 302, a first actuator 304, a second actuator 306, a pedestal lever member 308, a pedestal movement member 310, a base 316, and a connection means 318. Alternatively, the indexing mechanism could be implemented using a translation mechanism. A person skilled in the art will appreciate there a number of different mechanisms may be used to achieve an indexing mechanism.

The drive mechanism of the index mechanism is the first actuator 304, the second actuator 306, the pedestal lever member 308 and the pedestal movement member 310. These components of the index mechanism's drive mechanism are configured to move the index mechanism to different positions. In particular, these components are configured to rotate the pedestal 302.

Continuing with the present example embodiment as shown in FIG. 3A, the pedestal 302 is configured to rotate about its central axis. In FIG. 3A, the pedestal lever member 308 is shown in a first position. The first position is held by a locking mechanism. The first position can be considered a “locked” position as the locking feature 314 on the pedestal lever member 308 is engaged with the pedestal 302. In particular, the locking feature 314 is a locking interface configured to interface with a toothed face 320 of the pedestal 302. In this locked position, the pedestal 302 is unable to move.

In a second position (not shown) of the pedestal lever member 308, the pedestal lever member 308 is not engaged to lock the movement of the pedestal 302. In particular, the locking feature 314 is not engaged with the pedestal 302. In this particular embodiment, the locking feature 314 is not engaged with the toothed face 320 of the pedestal 302. In this second position, the pedestal movement member 310 is engaged with the pedestal and configured to move the pedestal 302. The second actuator 306 is configured to move the pedestal movement member 310. In particular, the second actuator 306 causes the pedestal movement member 310 to rotate about point 322. The movement of the second actuator 306 between the first contracted position and second extended position will rotate the pedestal movement member 310 about the rotation point 322. When the first actuator is in the second position (the extended position), the rotation is caused by the toothed face 312 of the pedestal movement member 310 engaging with the toothed face 320 of the pedestal 302 and moving. The pedestal movement member 310 moves such that the pedestal 302 moves. Alternatively described, the pedestal movement member 310 rotates about a point 322 and the toothed interface 312 of the pedestal movement member 310 that is engaged with the tooted face 320 of the pedestal 302, to rotate the pedestal 302.

The first actuator 304 moves from a first to a second position in order to move the pedestal lever member 308 from the first position (or locked position) to the second position (or moveable position).

While moving between the first and second positions of the pedestal lever member 308, at no point does either the pedestal lever member 308 or the pedestal movement member 310 not engage with the pedestal. By having no period with the pedestal 302 not being engaged with, the pedestal is unable to move due to any exterior or ambient forces.

In this example embodiment, the first and second actuators 304, 306 are linear actuators. In particular, the linear actuators are hydraulic actuators.

In this embodiment, the drill assembly 200 is coupled to the pedestal 302 such that when the pedestal 302 moves, the drill assembly 200 moves.

A person skilled in the art will appreciate that while this example embodiment is a rotation embodiment, other combinations and configurations of actuator, pedestal lever member, pedestal movement member, and pedestal can be used. An example alternative is a linear translatable pedestal instead of a rotation device.

The connection means 318 provides a connection to the baseplate assembly 400 and a fixed point for the actuator 304 to attach to.

The base 316 provides a further fixed connection to the baseplate assembly 400 and is movable coupled to the pedestal 302 such that the pedestal 302 is able to move about the baseplate assembly 400 and therefore the hot tap assembly 150. In this particular embodiment, the movement is rotational.

Referring to FIG. 3B, a detail of the indexing mechanism 300 is shown (with the baseplate assembly 400 which is described with respect to FIGS. 4A and 4B). As previously described with reference to FIG. 3A, the first actuator 304 is coupled to the connection means 318 and the pedestal lever member 308. Also shown is an adjustment mechanism 324. The adjustment mechanism 324 is used to adjust the length and position of the first actuator 304. The length and position of the first actuator 304 needs to be adjusted such that when the pedestal lever member 308 is in its first, locked position, the locking feature 314 does engage with the toothed face 320 of the pedestal 302 and is able to lock the pedestal from rotating. In this embodiment, the adjustment mechanism 324 is a bolt and screw. Alternative adjustment mechanisms include spring buttons and slots.

Referring to FIG. 3C, a detail of the indexing mechanism 300 is shown (with the baseplate assembly 400 which is described with respect to FIGS. 4A and 4B). As previously described with reference to FIG. 3A, the second actuator 306 is coupled to the pedestal movement member 310 and the pedestal lever member 308. Also shown is an adjustment mechanism 326. The adjustment mechanism 326 is used to adjust the length and position of the second actuator 306. The length and position of the second actuator 306 needs to be adjusted such the second actuator 306 has appropriate movement between a first and second position.

Baseplate Assembly

Referring to FIGS. 4A and 4B, according to a first embodiment, a baseplate assembly 400 is shown. The baseplate assembly 400 comprises a baseplate 402, a locking mechanism 404, and a hot tap receiving member 416. The hot tap receiving member 416 is an opening in the baseplate 402.

The locking mechanism 404 can also be described as an attachment member as it is configured to securely attach the remotely operable hot tap installation device 100 to the hot tap 150. The locking mechanism 404 in this example embodiment is a clamp. The locking mechanism 418 is configured securely attach the remotely operable hot tap installation device 100 to the hot tap 150. The locking mechanism 404 comprises a linear actuator 406 and a hot tap interface lock 408. In this embodiment the linear actuator 406 is a hydraulic actuator. Alternatively, other linear actuators could be used. In this embodiment, the hot tap interface lock 408 is a fork with a number of locking features to interface with the hot tap 150. The locking features of the hot tap interface lock 408 comprise any one or both of a key way 410 and locking pins 412.

The key way 410 lines up and interfaces with the keying and locking feature 162 on the hot tap 150. The width of the key way 410 matches that of the keying and locking feature 162 on the hot tap 150. The key way 410 comprises a peg. The size of the peg of the key way 410 matches the size of the hole of the keying and locking feature 162 on the hot tap 150.

The size of the locking pins 412 of the fork match the size of the holes of the keying and locking feature 164.

By using appropriately sized and toleranced features for the locking pins 412, key way 410, and keying and locking features 162, 164 of the hot tap assembly, a secure and accurate alignment can be achieved.

Alternative keying and locking features and mechanisms may also be used including permanent magnets, electromagnets, and screwing interfaces.

With reference to FIG. 4B, the locking mechanism 404 is aligned and locked in place with the baseplate 150. The keying and locking features 410, 412 of the locking mechanism 404 are engaged with the keying and locking features 162, 164 of the hot tap 150.

Also shown in FIG. 4B are drill studs 500 in their “home position” or initial depth ready for the drill assembly 200 (not shown in FIG. 4B) to apply torque and drill the drill studs 500 into the hot tap 150.

Referring back to FIG. 4A, a number of drill stud cartridges, or stud locations, 414 are shown in the baseplate assembly 400. The drill stud cartridges 414 are located about the hot tap receiving member 416. The drill stud cartridges 414 are configured to retain the drill studs 500. In this embodiment, the drill stud cartridges 414 comprise a threaded interface on the internal surface. The threaded interface corresponds to a thread on the drill studs 500 such that the drill studs 500 can screw into the drill stud cartridges 414. Alternatively, the drill stud cartridges 414 may be sized such that they form a friction fit with the drill studs 500.

In alternative embodiments, the stud locations are simple holes, such as pilot holes in the baseplate assembly 400. The studs 500 may be self-drilling studs and applying torque to the self-drilling studs 500 can result in the studs 500 drilling into and through the baseplate assembly 400 at the stud locations, e.g. guided by the pilot holes, and into (and optionally through) the wall of the vessel. In some embodiments, the studs 500 are pre-loaded in the drill stud cartridges, or locations, 414 prior to the installation process. For example, the pre-loading could be performed using the hot tap installation tool itself to apply torque to the studs 500 to insert the studs at least partly into the cartridges or stud locations 414. Then, after positioning the hot tap installation tool, when torque is applied to the studs 500 the studs are inserted further into the stud locations/cartridges 414, through the baseplate and into (and optionally through) the wall of the vessel.

The positioning of the drill stud cartridges 414 are described in greater detail in the “Indexed Locations” below. The drill studs 500 are described in greater detail with reference to FIG. 5.

### Drill Stud

Referring to FIG. 5, according to a first embodiment, a drill stud 500 is shown. The drill stud 500 comprises a collar 504, a collar thread 506, a coupling interface 508, and a drilling interface 510.

The collar 504 provides the user an indication where the “home position” or initial depth the drill stud 500 should be placed in the drill stud cartridges 414. The collar thread 506 interfaces with the interior surface of the drill stud cartridges 414. A user screws the drill studs 500 into the drill stud cartridges 414.

The coupling interface 508 is configured to engage with the drill stud torque application interface 208 of the drill assembly 200.

The drilling interface 510 comprises a threaded interface for drilling through the hot tap 150 and into the fluid vessel. Once drilled through, the drill stud 500 provides a holding force between the hot tap 150 to the fluid vessel.

### Indexing and Indexed Locations

As described above, the indexing mechanism 300 is configured to move the drill assembly 200. The indexing mechanism 300 moves the drill assembly 200 to predetermined locations. These predetermined locations are indexes. As such, the indexing mechanism 300 moves the drill assembly 200 into indexed locations.

These indexed locations are the locations of drill studs 500 for the drill assembly 200 to apply torque to. This can also be described as the locations of the drill stud cartridges 414.

In the present embodiment, to securely couple this example hot tap assembly 150 to a fluid vessel, at least three drill studs 500 need to be installed. Therefore at least three drill stud cartridges 414 are present. Thus three primary stud locations may be provided for securing the hot tap assembly 150. Additional secondary stud locations may be provided for redundancy, e.g. in case a stud in one of the primary stud locations fails.

The drill studs 500 are installed by the drill assembly 200 applying torque to the drill studs 500 and the drill studs 500 coupling the hot tap 150 to the fluid vessel. Other hot taps may require different numbers of drill studs 500 to securely couple the hot tap to a fluid vessel. The number of drill studs required will depend on any one or more of the following: shape and size of the hot tap, the shape and size of the fluid vessel, the ambient conditions of the fluid vessel (such as whether it is underwater which will have pressure requirements or not). A person skilled in the art will appreciate that other conditions may influence the number of drill studs 500 required.

The at least three drill studs 500 required to securely couple the hot tap 150 to the fluid vessel are placed roughly equally spaced apart around the flange 160 of the hot tap 150. In other words, the drill studs 150 should be approximately 120 degrees apart from each other about the centre of the hot tap 150. Between 90 degrees and 150 degrees is an acceptable range to provide the secure coupling between the hot tap 150 and the fluid vessel. The at least three drill studs 500 should have rotational symmetry. If more than three drill studs 500 are used, then preferably they should be spaced apart substantially equally about the hot tap 150.

The drill stud cartridges 414 and/or drill studs 500 can also be described as being arranged into groups. In the present embodiment, three groups of drill stud cartridges 414 are used. In particular, the groups of cartridges contain at least three drill stud cartridges 414. The three groups of drill stud cartridges 414 are placed evenly about a hot tap receiving member 416. The indexing mechanism 300 is configured to index the drill stud cartridges 414 positions.

With reference to FIG. 6, the baseplate 400 is shown with drill stud cartridges 414. The drill stud torque application interface 208 of the drill assembly 200 is shown. The drill stud torque application interface 208 is in a first indexed position above the middle of the three drill stud cartridges 414. In this position, the drill assembly 200 lowers the drill stud torque application interface 208 and applies torque to the drill stud 500 (not shown in this figure) and drills in the drill stud 500. Once the drill stud 500 is drilled in, the drill assembly 200 raises the drill stud torque application interface 208 and the indexing mechanism 300 moves the drill assembly 200 to another indexed position to drill another drill stud 500 into the hot tap assembly 150 and fluid vessel. This process continues until all drill studs 500 have been drilled in. Alternatively, this process continues until sufficient drill studs 500 have been drilled in. To provide redundancy in case of failure of the drill studs 500 or issues when drilling the drill studs 500 into the hot tap assembly 150 and/or vessel, groups of drill studs 500 are used. In this example embodiment, three groups of three drill stud cartridges 414 are used. FIG. 4A shows an alternative view showing two of the three groups (the last one is obscured by the locking mechanism 404). Three are shown by way of example. At least two drill studs 500 per group are required for redundancy. More than three could be used also for increased levels of redundancy.

To establish the secure coupling between the hot tap assembly 150 and the fluid vessel, at least one drill stud 500 from each group needs to be drilled in. When one drill stud 500 from each group is drilled in, appropriate spacing between the drill studs 500 is achieved such that a secure coupling between the hot tap assembly 150 and fluid vessel is achieved. The drill stud 500 groups are placed about the hot tap 150 such that if one from each group is installed, no matter which of the three in the group is installed, the spacing of 90 degrees to 150 degrees is achieved.

As an alternative to the drill stud 500 grouping is continuous drill stud cartridges 414 about the baseplate opening 416. This means that, when in use, the operator can install drill studs 500 in any of the locations and should still be able to achieve the spacing of 90 degrees to 150 degrees required for secure coupling between the hot tap 150 and the fluid vessel.

### Remote Operated Vehicle

Hot tap assemblies 150 often need to be installed in environments that are not hospitable to humans. These environments may be in deep water or include chemical spills. Such environments require ROVs to install and operate machinery to avoid any harm that might come to human divers/operators. In other situations, it is simply more cost effective to use an ROV.

In the present embodiment, the remotely operable hot tap installation device 100 is configured for use with a remote operated vehicle. In particular, the remotely operable hot tap installation device 100 is configured for use with an underwater remote operated vehicle.

Alternatively, the remotely operable hot tap installation device 100 is configured for use by a human operator directly.

### System and Method of Extracting Oil

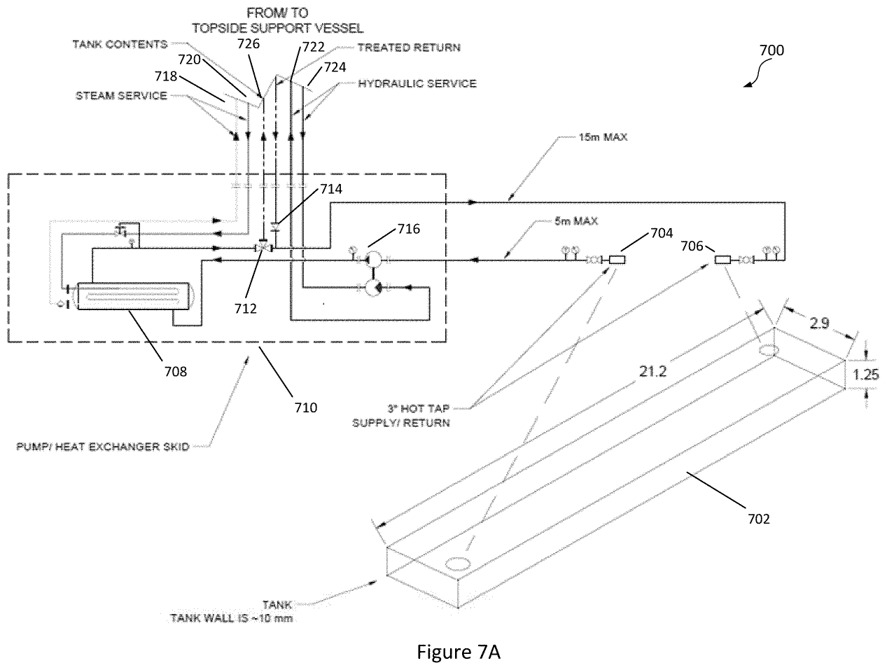

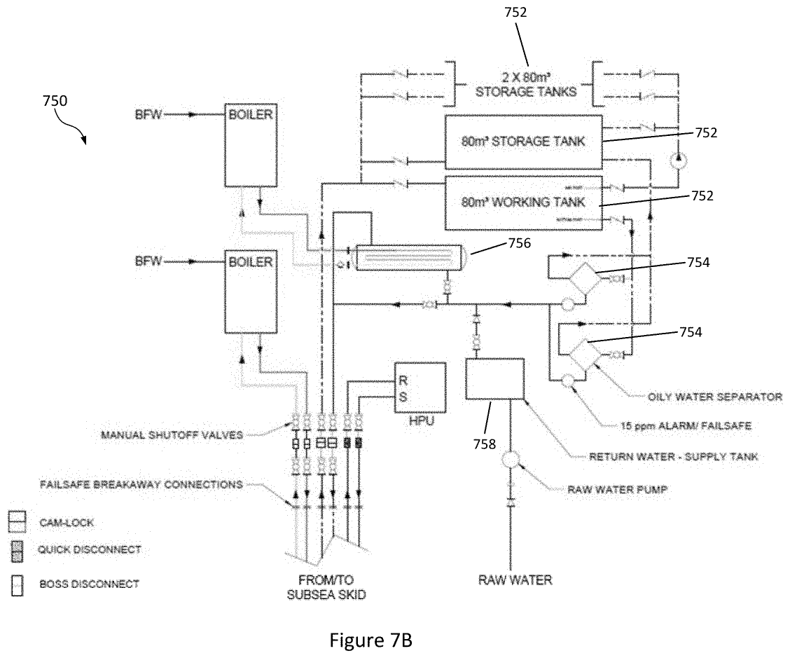

Referring to FIGS. 7A and 7B, a schematic diagram of an oil extraction system is shown. FIG. 7A shows the undersea arrangement 700 and FIG. 7B shows the above sea arrangement 750. The above sea arrangement 750 is on a boat nearby the undersea arrangement 700 in the present example.

The purpose of this system is to extract a fluid from a vessel 702 under water. In the present example, the fluid in the vessel 702 is oil. A person skilled in the art will appreciate that other fluids can be extracted without substantial modification of the method and system. In this example embodiment, the oil needs to be extracted in a manner such that none is spilt into the surrounding environment.

As the vessel 702 is underwater in the present example, the oil inside is very cold. Moving cold oil is a difficult task as it becomes very viscous and difficult to pump out. The oil is pumped out of the vessel 702 and into a heat exchange device 708 to heat the oil up. Two hot tap assemblies 704, 706 are installed on the vessel 702 to fluidly couple the vessel to the heat exchange device 708. The oil is able to be pumped out partially separately from any water that may be present because the oil is immiscible in water and floats on top water using a decanting method. This decanting is achieved by placing the hot tap assemblies in the appropriate location such that the hot tap assembly 704 is higher and will function as an outlet from the vessel 702 for the oil. The decanting method can be used to remove substantially only oil. By fluidly coupling the input and output of the vessel 702 using the hot tap connections 704, 706 an “underwater oil circuit” is established to heat up all of the oil in vessel 702. Also connected into the underwater oil circuit is a treated return path 714 from the above sea arrangement 750. The treated return path 714 provides heated water and a heated filtered oil-water mixture described later with reference to the above sea arrangement 750.

With the fluid warmed and circulating, the warm fluid is pumped to the above sea arrangement 750 via the tank contents connection 726. The fluid will be mostly oil, but there may be other substances as the decanting system is generally not perfect. On to the above sea arrangement 750, the warmed fluid is received into storage tanks. The storage tanks in this example embodiment are 80 m³. The warm fluid is filtered using oil-water separators. Multiple passes through the oily water separators 754 are sometimes required. If the oil in the fluid is more than 15 ppm, it is recirculated into the storage tanks for another pass through the oily water separators 754. If the oil content in the warm fluid is less than 15 ppm, it is pumped into the above sea arrangement 750 section of the underwater oil circuit. The above sea arrangement 750 part of the underwater oil circuit also comprises a heat exchange device 756.

Referring to FIG. 7A, a vessel 702 has two hot tap connections on it. In this example embodiment, the vessel 702 is a tank. Two hot taps connections 704, 706 are installed on the vessel 702 using the remotely operable hot tap installation 100 as described with reference to FIGS. 1 through 6. The first hot tap connection 704 is used to fluidly couple the vessel 702 to the input of a heat exchange device 708. The heat exchange device 708 is housed within a pump/heat exchanger skid 710. The second hot tap connection 706 is used to fluidly couple the vessel to a first output of a y-valve 712. The input of the y-valve 712 is fluidly coupled to the output of the heat exchange device 708. The second output of the y-valve 712 is connected to the above sea arrangement 750 via the tank contents connection 726. Also fluidly coupled to the second hot tap 706 is a treated return path 714 from the above sea arrangement 750. A pump 716 is connected inline between the first hot tap connection 704 and the heat exchange device 708 in order to pump the contents of the vessel 702 out and into the heat exchange device 708. Supporting steam pipes 718, 720 are connected to the above sea arrangement 750. Supporting hydraulics lines 722, 724 for the pump system 716 are also connected to the above sea arrangement 750.

Referring to FIG. 7B, the above sea arrangement 750 is shown. Oil mixture received from the underwater arrangement 700 is received in storage tanks 752. The storage tanks 752 are fluidly coupled to oily water separators 754 such that the oily water in the tanks 752 is passed through the oily water separators 754 to filter the water from the oil in the oily water from the vessel 702. The water output of the oily water separators is fluidly coupled to a further heat exchange device 756 and to the treated return path 714. The filtered water, if oil content is less than 15 ppm, will be outputted via the water output of the oily water separators. If the oil content of the oily water is greater than 15 ppm then the oily water mixture is returned to the storage tanks for filtering again 754. A return water supply tank 758 is also fluidly coupled to the further heat exchange device 756 and to the treated return path 714. The return water supply tank 758 is fluidly coupled to a pump to pump in water from a raw water source.

The described embodiments of the invention are only examples of how the invention may be implemented. Modifications, variations and changes to the described embodiments will occur to those having appropriate skills and knowledge. These modifications, variations and changes may be made without departure from the scope of the claims.

1. A remotely operable hot tap installation tool for securing a hot tap assembly to a vessel, wherein the hot tap assembly comprises:
a connection plate,
a fluid connection port,
a plurality of attachment stud locations,
a hole-drilling assembly; and
wherein the vessel is arranged to contain fluid and has a wall; the remotely operable hot tap installation tool comprising:
a releasable securing and stabilising arrangement configured to securely position the tool with respect to the vessel by attaching to the vessel wall;
a hot tap assembly holder arranged to hold the hot tap assembly with respect to the tool with the connection plate adjacent the vessel wall when the releasable securing and stabilising arrangement is activated;
at least one first drive mechanism configured to apply torque to studs at the plurality of attachment stud locations of the hot tap assembly to securely fasten the hot tap assembly to the vessel;
a second drive mechanism configured to apply torque to the hole-drilling assembly of the hot tap assembly to cut a hole into the fluid vessel wall to allow fluid communication between the fluid vessel and hot tap;
an indexing mechanism configured to move the first drive mechanism between multiple attachment stud locations; wherein
the attachment stud locations comprise at least three primary attachment stud locations for securing the hot tap assembly to the vessel and at least one secondary attachment stud location and wherein the combination of the or each first drive mechanism and the indexing mechanism is arranged to apply torque selectively to attachment studs at all primary attachment stud locations and at least one secondary attachment stud location.

2. A remotely operable hot tap installation tool according to claim 1, wherein the releasable securing and stabilising arrangement comprises one or more attachment elements selected from movable magnets, electromagnets and suction feet.

3. A remotely operable hot tap installation tool according to claim 1, wherein the indexing mechanism comprises a third drive mechanism, for moving the first drive mechanism between multiple attachment stud locations.

4. A remotely operable hot tap installation tool according to claim 1, wherein the indexing mechanism is configured to move the first drive mechanism to predetermined index locations corresponding to the attachment stud locations (at least to all the primary attachment stud locations and at least one secondary attachment stud location).

5. A remotely operable hot tap installation tool according to claim 1, wherein the indexing mechanism comprises a locking mechanism.

6. A remotely operable hot tap installation tool according to claim 1, wherein the net weight of the hot tap installation tool in water is adjustable between 30 kg and neutrally buoyant.

7. A remotely operable hot tap installation tool according to claim 1, wherein:
the attachment stud locations comprise at least one secondary attachment stud location for each of the primary attachment stud locations (so there are at least six stud locations in total), and wherein the combination of the or each first drive mechanism and the indexing mechanism is arranged to apply torque selectively to attachment studs at all secondary attachment stud locations.

8. A remotely operable hot tap installation tool according to claim 7, wherein:
the attachment stud locations comprise more than one secondary attachment stud location for each of the primary attachment stud locations (so there are e.g. at least nine stud locations in total).

9. A remotely operable hot tap installation tool according to claim 1, wherein:
the primary attachment stud locations are substantially evenly spaced about the hot tap assembly, e.g. around the circumference of the connection plate.

10. A remotely operable hot tap installation tool according to claim 9, wherein:
the secondary attachment stud locations are offset from the primary attachment stud locations.

11. A remotely operable hot tap installation tool according to claim 1, wherein:
the secondary attachment stud locations are substantially evenly spaced about the hot tap assembly, e.g. around the circumference of the connection plate.

12. An underwater remote operated vehicle comprising the hot tap installation tool of claim 1.

13. A fluid vessel comprising a hot tap installed using a hot tap installation tool according to claim 1.

14. A method of extracting a fluid from a fluid vessel, comprising the steps:
installing a first hot tap assembly and a second hot tap assembly in a wall of the fluid vessel;
fluidly coupling the first hot tap assembly to a input of a heat exchange device;
fluidly coupling the second hot tap assembly to an output of the heat exchange device;
fluidly coupling an oil storage tank to the output of the heat exchange device;
circulating a fluid in the fluid vessel through the heat exchange device;
applying heat to the fluid in the fluid vessel as it flows through the heat exchange device; and
pumping the heated fluid from the fluid vessel into the oil storage tank.

15. A method according to claim 14, wherein the fluid in the fluid vessel comprises water and another fluid and wherein the other fluid or water is decanted from the fluid from the fluid vessel.

16. A method according to claim 15, wherein the other fluid is oil and the decanted fluid is processed using an oil separator system.

17. A method according to claim 16, wherein the water output of the oil separator is heated and pumped into the fluid vessel.

18. A method according to claim 14, wherein the oil storage tank is part of an above sea arrangement.

19. A method according to claim 14, wherein the circulating the fluid in the fluid vessel is performed at a rate of between 1 m³/s and 30 m³/s.

20. A method according to claim 14, wherein the heat exchange device provides an energy exchange rate of between 400 KW and 1000 KW.

21. A method according to claim 14, comprising pumping the heated fluid from the fluid vessel into the oil storage tank only after the fluid and/or the other fluid has reached its pour point.

22. A method according to claim 14, wherein the first hot tap assembly and second hot tap assembly are installed using a remotely operable hot tap installation device.
